(19) United States
(12) Patent Application Publication
(10) Pub. No.: US 2026/0024400 A1
(43) Pub. Date: Jan. 22, 2026

(54) SYSTEMS AND METHODS FOR DISPLAYING VISUAL EFFECTS CORRESPONDING TO EVENTS THAT OCCUR IN CONNECTION WITH BONUS FEATURES OF ELECTRONIC WAGERING GAMES

(71) Applicant: Aristocrat Technologies, Inc., Las Vegas, NV (US)

(72) Inventors: Eric Boese, Decatur, GA (US); Ronald Williams, II, Atlanta, GA (US); Brandon Richard, Lawrenceville, GA (US); Jae Yi, Alpharetta, GA (US)

(21) Appl. No.: 18/780,435

(22) Filed: Jul. 22, 2024

(51) Int. Cl. G07F 17/32

(52) U.S. Cl. CPC G07F 17/3211; G07F 17/326

(57) ABSTRACT

A system for displaying visual effects corresponding to events that occur in connection with bonus features of electronic wagering games may include and/or implement a display device and/or circuitry. In one example, the circuitry may be configured to detect a first event that triggers a bonus feature of an electronic wagering game and to detect, during implementation of the bonus feature, a second event that triggers a first collection of one or more values represented by one or more symbols on one or more reels of the electronic wagering game. In this example, the circuitry may also be configured to perform, upon completion of the bonus feature, a second collection of the values represented by the symbols and to then direct the display device to render one or more visual effects corresponding to the first event and the second event. Various other systems and methods are also disclosed.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Other gaming establishments may provide Class II games, which are typically bingo-based games.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

As will be described in greater detail below, the instant disclosure generally relates to systems and methods for displaying visual effects corresponding to events that occur in connection with bonus features of electronic wagering games. In some examples, a system for accomplishing such a task may include and/or implement a display device and/or circuitry. In one example, the circuitry may be configured to detect a first event that triggers a bonus feature of an electronic wagering game and to detect, during implementation of the bonus feature, a second event that triggers a first collection of one or more values represented by one or more symbols on one or more reels of the electronic wagering game. In this example, the circuitry may also be configured to perform, upon completion of the bonus feature, a second collection of the values represented by the symbols on the reels and to then direct the display device to render one or more visual effects corresponding to the first event and the second event.

In some examples, the circuitry may be further configured to direct the display device to render, in a graphical interface of the electronic wagering game, one or more metamorphic visuals corresponding to the reels. In one example, the circuitry may be further configured to detect, prior to the implementation of the bonus feature, activity that involves the reels and results from an interaction between a user and the electronic wagering game and to then direct the display device to modify at least one of the metamorphic visuals prior to the implementation of the bonus feature based at least in part on the activity.

In some examples, the circuitry may be further configured to detect, during the implementation of the bonus feature, activity that involves the reels and results from an interaction between a user and the electronic wagering game and to then direct the display device to modify at least one of the metamorphic visuals during the implementation of the bonus feature based at least in part on the activity. In one example, the circuitry may be further configured to detect at least one metric that represents apparent progress toward unlocking the bonus feature in connection with at least one of the metamorphic visuals and to then direct the display device to modify the at least one of the metamorphic visuals commensurate with the metric.

In some examples, the first event may include and/or involve determining that the metric that represents the apparent progress toward unlocking the bonus feature has reached a certain threshold. In one example, the metamorphic visuals may include and/or represent a plurality of graphical bowls configured to fill with graphical coins commensurate with the metric. Additionally or alternatively, the visual effects may include and/or represent a first animation that corresponds to the first event and involves at least one of the graphical bowls or the graphical coins and/or a second animation that corresponds to the second event and involves at least one of the graphical bowls or the graphical coins.

In some examples, the circuitry may be further configured to allot a certain number of reel spins to a user in connection with the bonus feature and to terminate the bonus feature upon determining that the user has completed the certain number of reel spins. In one example, the circuitry may be further configured to attribute, to the user as part of the first collection, the values represented by the symbols on the reels in response to the first event. In this example, the circuitry may be further configured to attribute, to the user as part of the second collection, the values represented by the symbols on the reels in response to the second event.

In some examples, the circuitry may be further configured to detect at least one metric that represents apparent progress toward unlocking the first collection during the bonus feature in connection with at least one of the metamorphic visuals and to then direct the display device to modify the at least one of the metamorphic visuals commensurate with the metric. In one example, the second event includes and/or involves determining that the metric that represents the apparent progress toward unlocking the first collection has reached a certain threshold. Additionally or alternatively, the metamorphic visuals may include and/or represent a first metamorphic visual and a second metamorphic visual. In certain implementations, each symbol may signify and/or represent a first value corresponding to the first metamorphic visual and a second value corresponding to the second metamorphic visual.

In some examples, the circuitry may be further configured to attribute, to the user as part of the first collection, a first instance of each first value corresponding to the first metamorphic visual and a first instance of each second value corresponding to the second metamorphic visual. In one example, the circuitry may be further configured to attribute, to the user as part of the second collection, a second instance of each first value corresponding to the first metamorphic visual and a second instance of each second value corresponding to the second metamorphic visual.

In some examples, the circuitry may be further configured to detect, after the second event and before the completion of the bonus feature, an addition of at least one other symbol on the reels. In one example, the circuitry may be further configured to attribute, to the user as part of the second collection, at least one other value represented by the other symbol on the reels in response to the second event.

Similarly, a corresponding computer-implemented method may include detecting, by circuitry, a first event that triggers a bonus feature of an electronic wagering game. In some examples, the corresponding computer-implemented method may include detecting, by the circuitry during implementation of the bonus feature, a second event that triggers a first collection of one or more values represented by one or more symbols on one or more reels of the electronic wagering game. In one example, the corresponding computer-implemented method may include performing, by the circuitry upon completion of the bonus feature, a second collection of the values represented by the symbols on the reels. Additionally or alternatively, the corresponding computer-implemented method may include directing, by the circuitry, a display device to render one or more visual effects corresponding to the first event and the second event.

In some examples, a non-transitory computer-readable medium that facilitates and/or implements the above-identified method may include one or more computer-executable instructions. When executed by at least one hardware processor of a computing device, the computer-executable instructions may cause the hardware processor to detect a first event that triggers a bonus feature of an electronic wagering game. In one example, when executed by the hardware processor of the computing device, the computer-executable instructions may also cause the hardware processor to detect, during implementation of the bonus feature, a second event that triggers a first collection of one or more values represented by one or more symbols on one or more reels of the electronic wagering game. In this example, when executed by the hardware processor of the computing device, the computer-executable instructions may also cause the hardware processor to perform, upon completion of the bonus feature, a second collection of the values represented by the symbols on the reels. Additionally or alternatively, when executed by the hardware processor of the computing device, the computer-executable instructions may cause the hardware processor to direct a display device to render one or more visual effects corresponding to the first event and the second event.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an exemplary diagram showing several electronic gaming machines (EGMs) networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram of an exemplary system for displaying visual effects corresponding to events that occur in connection with bonus features of electronic wagering games according to one or more implementations of this disclosure.

FIG. 5 is a block diagram of an exemplary graphical interface of an electronic wagering game according to one or more implementations of this disclosure.

FIG. 6 is a block diagram of an exemplary graphical interface of an electronic wagering game according to one or more implementations of this disclosure.

FIG. 7 is a block diagram of an exemplary graphical interface of an electronic wagering game according to one or more implementations of this disclosure.

FIG. 8 is a block diagram of an exemplary graphical interface of an electronic wagering game according to one or more implementations of this disclosure.

FIG. 9 is a block diagram of an exemplary graphical interface of an electronic wagering game according to one or more implementations of this disclosure.

FIG. 10 is a block diagram of an exemplary graphical interface of an electronic wagering game according to one or more implementations of this disclosure.

FIG. 11 is a block diagram of an exemplary graphical interface of an electronic wagering game according to one or more implementations of this disclosure.

FIG. 12 is a block diagram of an exemplary graphical interface of an electronic wagering game according to one or more implementations of this disclosure.

FIG. 13 is a flow diagram of an exemplary computer-implemented method for displaying visual effects corresponding events that occur in connection with bonus features of electronic wagering games according to one or more implementations of this disclosure.

Throughout the drawings, identical reference characters and descriptions may indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the instant disclosure are generally directed to electronic gaming systems for wagering. In some examples, the electronic gaming systems may include and/or represent an EGM having a display, one or more input devices, a wager acceptor, and/or a game controller coupled to the display, the input devices, and/or the wager acceptor. The game controller may be configured to control the display to present and/or display an electronic wagering game. The game controller may present and/or display these various wager options in the electronic wagering game.

In some examples, the electronic wagering game may be governed by different rules and/or pay tables. In one example, the game controller may be configured to operate the electronic wagering game using a common wagering event (e.g., a reel spin). The game controller may also enable users to make certain selections (e.g., wager selections) in the electronic wagering game.

In some examples, an electronic wagering system may implement a graphical slot machine that includes and/or represents a set of reels that spin in connection with a user's wager. In one example, the graphical slot machine may include and/or represent a set of metamorphic visuals (e.g., graphical bowls that fill with graphical coins) whose status and/or condition depicts the user's apparent progress toward unlocking a bonus feature, such as a hold-and-spin feature. For example, one or more metrics and/or measurements may indicate and/or represent a duration and/or an amount of time since the graphical slot machine last awarded and/or granted a hold-and-spin feature as a bonus to a user. In this example, the metamorphic visuals may depict and/or graphically represent the duration and/or amount of time that has passed and/or elapsed since the graphical slot machine last awarded and/or granted a hold-and-spin feature as a bonus to a user.

In some examples, the metrics and/or measurements may correspond to, represent, and/or be associated with the user's performance, apparent progress, and/or wagers while playing the graphical slot machine. In one example, the metamorphic visuals may depict and/or graphically represent the user's performance, apparent progress, and/or wagers commensurate with that metrics and/or measurements.

In some examples, as the metrics and/or measurements increase, so too may the corresponding metamorphic visuals. For example, as a user plays a graphical slot machine, metrics representing the duration since the last awarded bonus may increase. In this example, metamorphic visuals depicted in the graphical slot machine may reflect, follow, and/or parallel the status and/or condition of such metrics. In one example, once one or more of the metrics reaches a certain threshold, the graphical slot machine may award and/or grant a hold-and-spin feature as a bonus to the user. In certain implementations, the graphical slot machine may apply and/or perform one or more visual effects to indicate and/or reflect the award and/or grant of the hold-and-spin feature. For example, the graphical slot machine may animate the metamorphic visuals in one way or another (e.g., graphical coins spilling over and/or out of graphical bowls) in response to the award and/or grant of the hold-and-spin feature.

In some examples, the metamorphic visuals may stay and/or remain active in a similar or identical way throughout implementation of the hold-and-spin feature. For example, the metamorphic visuals may reflect the amount of time that has elapsed since the hold-and-spin was awarded even during the implementation of the hold-and-spin feature. In one example, the graphical slot machine may award and/or grant a mid-bonus win-all, collect-all, and/or roll-up during the implementation of the hold-and-spin feature. In certain implementations, as part of this mid-bonus win-all, collect-all, and/or roll-up, the graphical slot machine may give the value of cash-on-reel (COR) symbols appearing on the reels to the user before the hold-and-spin feature ends.

In some examples, each COR symbol that appears on the reels during the implementation of the hold-and-spin feature may correspond to and/or represent at least one value (e.g., a monetary value and/or credit). In one example, the COR symbols may each include and/or represent multiple values corresponding to the different metamorphic visuals. For example, one value shown on a COR symbol may correspond to a metamorphic visual depicted on one side of the graphical slot machine, and another value shown on that COR symbol may correspond to another metamorphic visual depicted on another side of the graphical slot machine. Accordingly, when the mid-bonus win-all, collect-all, and/or roll-up is awarded and/or granted, the graphical slot machine may attribute one value on each COR symbol to the user via one metamorphic visual and another value on each COR symbol to the user via the other metamorphic visual.

In some examples, after the mid-bonus win-all, collect-all, and/or roll-up, the user may continue spinning the reels to obtain one or more additional COR symbols during the remainder of the hold-and-spin feature. In one example, the same values attributed to the user in the mid-bonus win-all, collect-all, and/or roll-up may be attributed to the user again at the end of the hold-and-spin feature. In this example, the graphical slot machine may also attribute the values of the additional COR symbols that appeared on the reels after the mid-bonus win-all, collect-all, and/or roll-up at the end of the hold-and-spin feature.

Some electronic wagering systems may suffer from certain technical problems and/or deficiencies that impair users' experiences and/or enjoyment. For example, an electronic wagering system may be unable to effectively communicate and/or convey that certain bonuses (e.g., mid-bonus win-alls, collect-alls, and/or roll-ups) have been awarded and/or granted to users throughout gameplay-especially in loud environments like casinos. The electronic gaming systems and methods described herein may address, resolve, and/or mitigate some of these technical problems and/or deficiencies. For example, a graphical slot machine implemented by an electronic gaming system may effectively communicate and/or convey certain occurrences and/or events (e.g., the hold-and-spin award and/or the mid-bonus win-all, collect-all, and/or roll-up) through visual effects and/or animations applied to and/or implemented by the metamorphic visuals.

As a specific example, the graphical slot machine may coordinate and/or synchronize mid-bonus win-alls, collect-alls, and/or roll-ups with certain visual effects and/or animations that are applied to and/or implemented by the metamorphic visuals. By doing so, the graphical slot machine may be able to effectively communicate and/or convey, to users, that the users have been awarded such mid-bonus win-alls, collect-alls, and/or roll-ups-even in loud environments like casinos. Otherwise, the users may struggle to comprehend what is actually happening in the gameplay of the graphical slot machine and/or with the users' wagering, and such struggles may impair the users' experiences and/or enjoyment with the graphical slot machine. Accordingly, the graphical slot machine's coordination between the metamorphic visuals and the mid-bonus win-alls, collect-alls, and/or roll-ups substantially solves the communication and/or conveyance problem relating to the users' comprehension of what is actually happening in the gameplay.

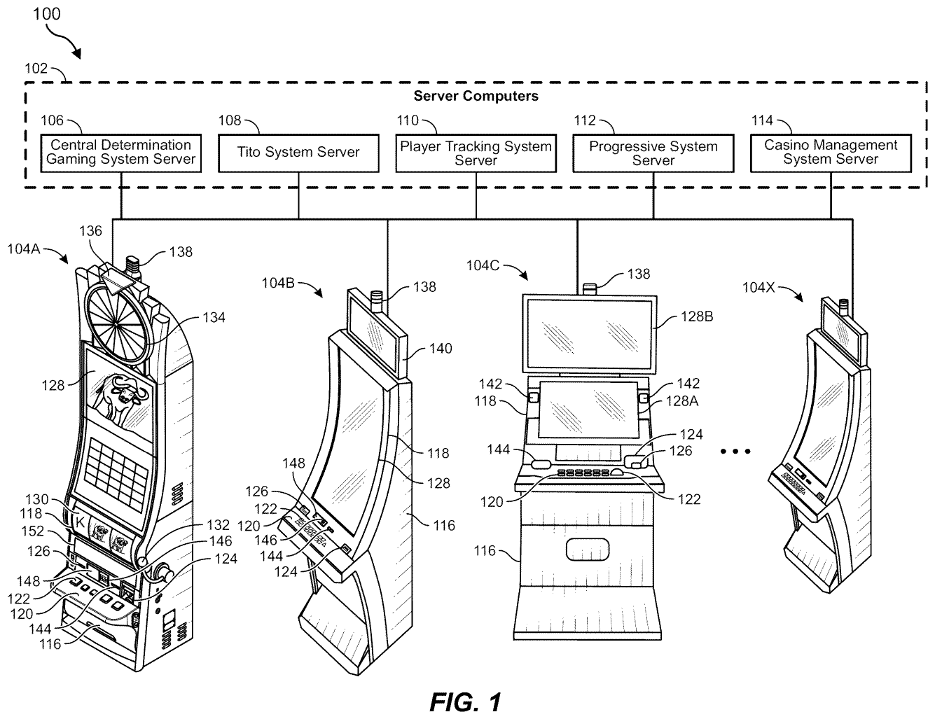

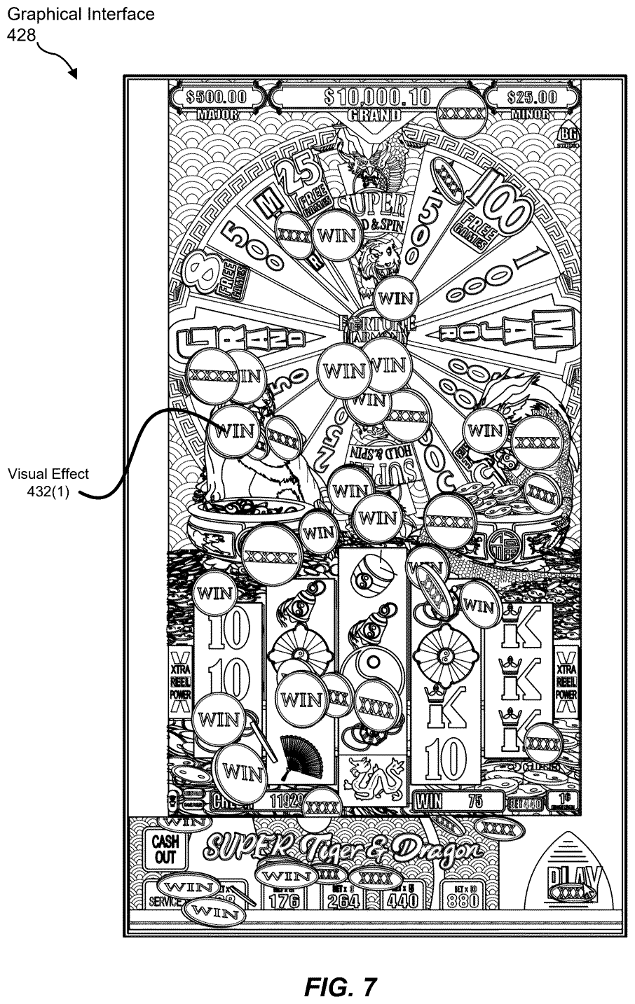

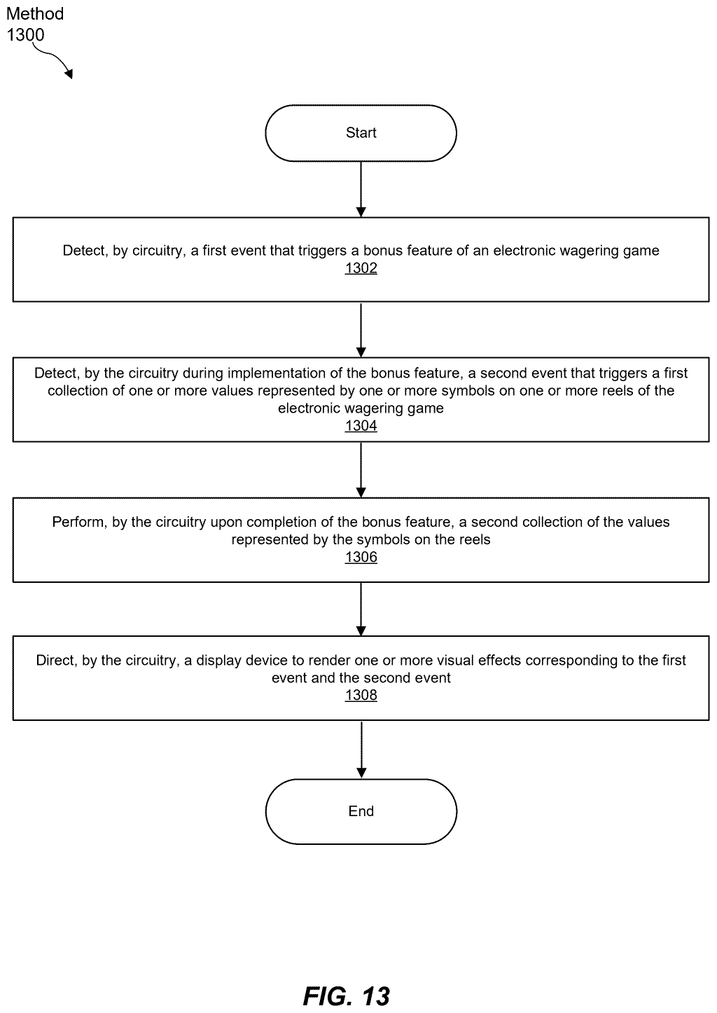

The following will provide, with reference to FIGS. 1-12, detailed descriptions of exemplary apparatuses, devices, systems, components, configurations, features, or implementations for displaying visual effects corresponding to events that occur in connection with bonus features of electronic wagering games. In addition, detailed descriptions of methods for displaying visual effects corresponding to events that occur in connection with bonus features of electronic wagering games will be provided in connection with FIG. 13.

### Inventor(S): the Following Section Is Boilerplate and Does Not Require Your Review

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

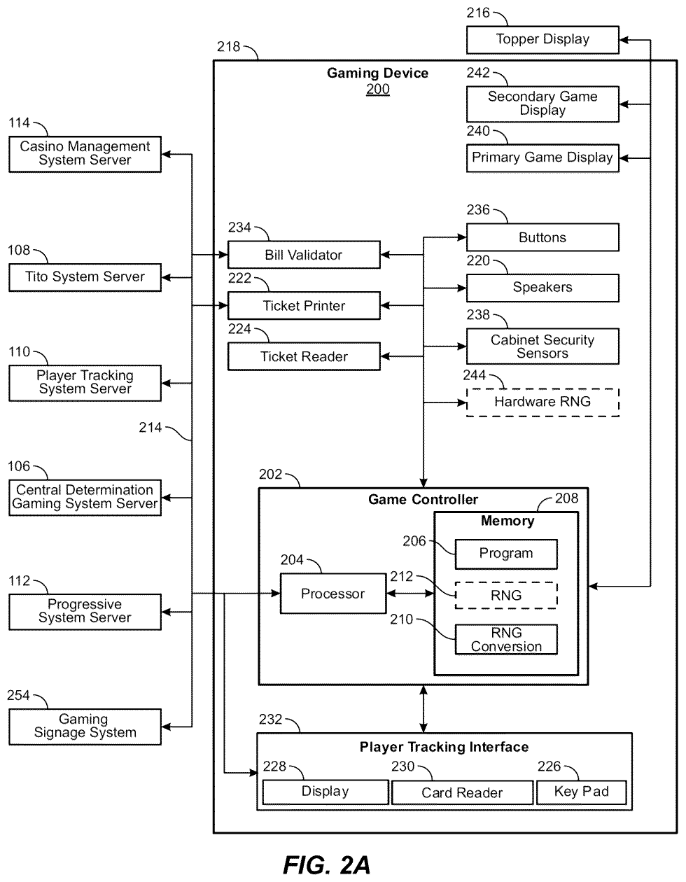

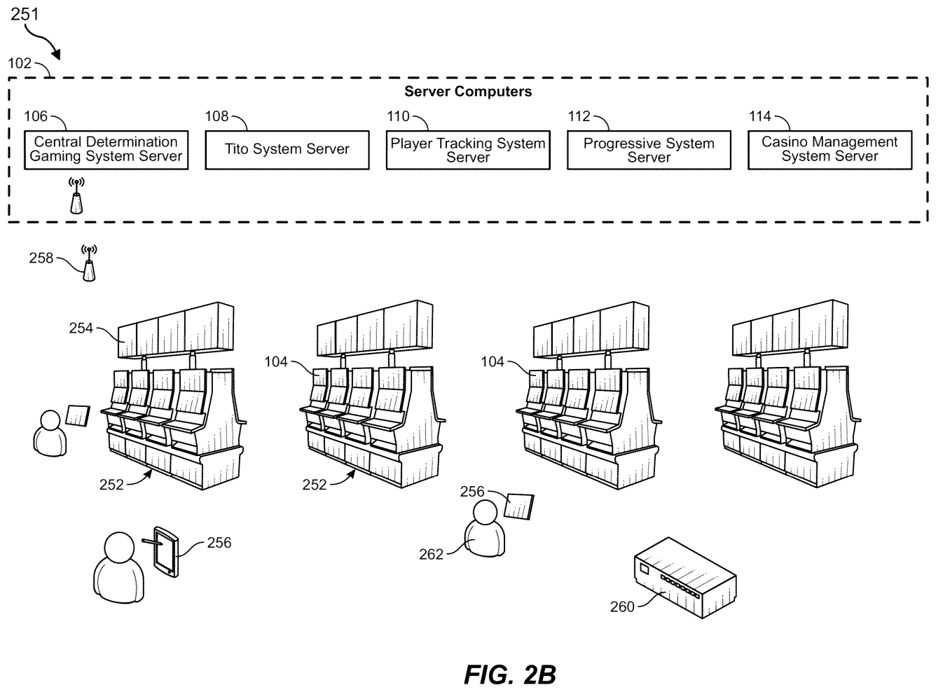

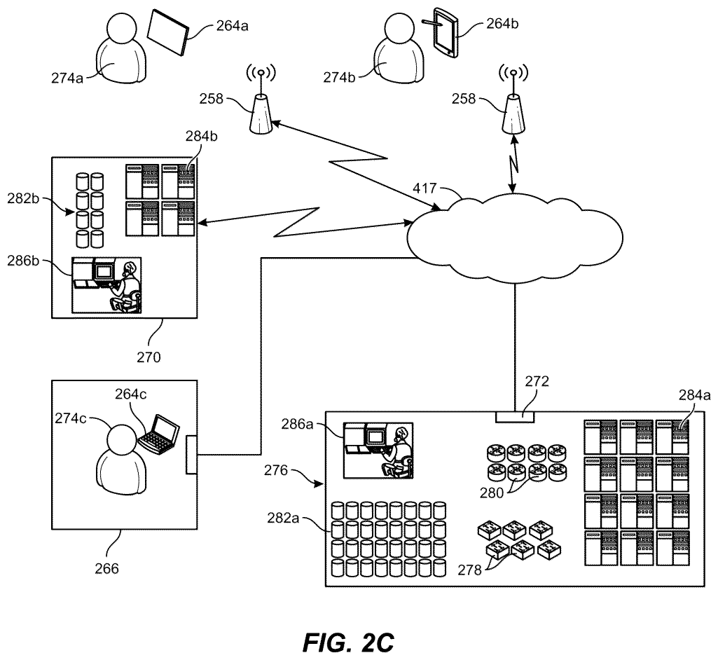

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

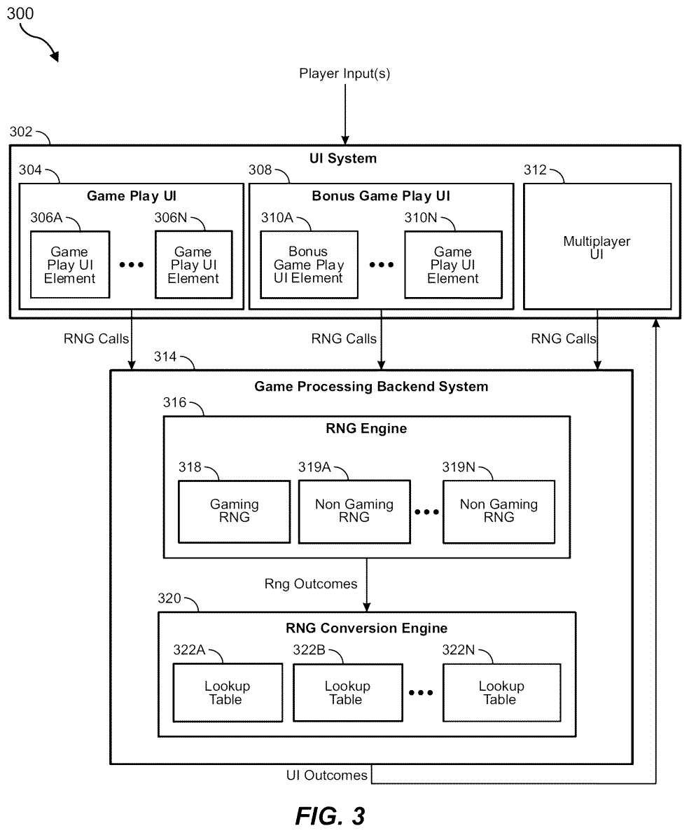

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### End of Boilerplate

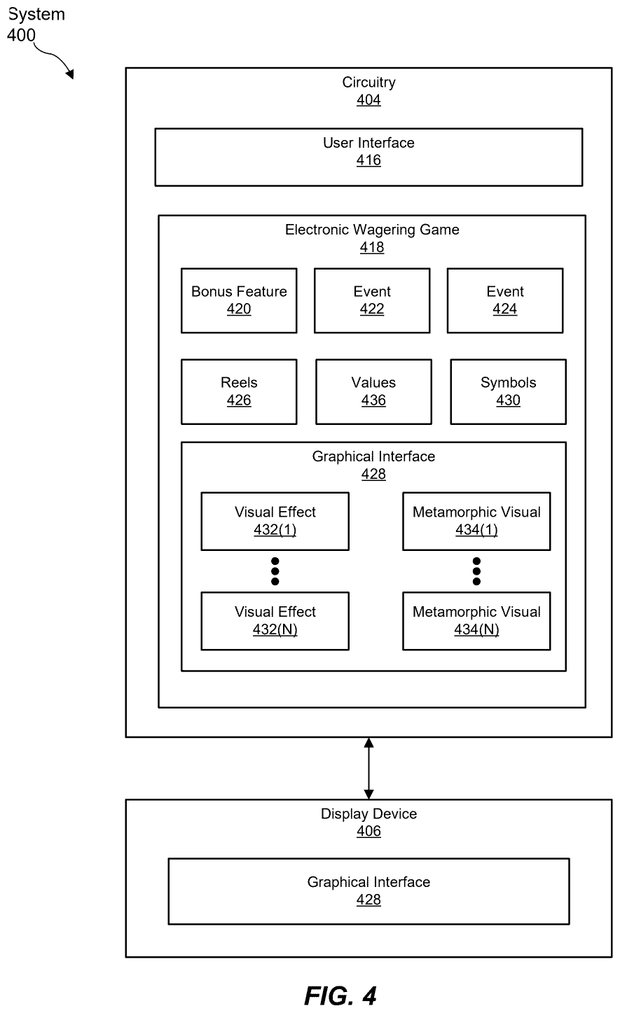

FIG. 4 illustrates an exemplary system 100 for displaying visual effects corresponding to events that occur in connection with bonus features of electronic wagering games. As illustrated in FIG. 1, system 100 may include and/or represent circuitry 404 and display device 406. In some examples, circuitry 404 may implement and/or execute an electronic wagering game 418 in conjunction with display device 406. In one example, circuitry 404 may include and/or represent a user interface 416 that enables a user to enter and/or provide input in connection with electronic wagering game 418. In this example, circuitry 404 may direct and/or cause display device 406 to render and/or present a graphical interface 428 of electronic wagering game 418 for viewing by the user.

In some examples, electronic wagering game 418 may include and/or represent reels 426 configured to spin in connection with wagers made by the user. In one example, reels 426 may include and/or represent symbols 430 that spin, rotate, and/or change during gameplay. In this example, certain combinations and/or sequences of symbols 430 across reels 426 may constitute a win and/or increase for the user. As a result, the electronic wagering game 418 may award and/or grant, to the user, a certain monetary value and/or credit associated with one or more of symbols 430 and/or their corresponding combinations or sequences.

In some examples, graphical interface 428 of electronic wagering game 418 may include and/or represent one or more metamorphic visuals 434(1)-(N). In one example, metamorphic visuals 434(1)-(N) may include and/or represent graphical objects that represent certain features and/or attributes of the gameplay, such as values and/or credits accumulated by one or more users, increments on progressives, durations and/or amounts of time since the last time a certain bonus was awarded, etc. In this example, metamorphic visuals 434(1)-(N) may include and/or represent perceived-persistence graphics, pseudo-persistence graphics, and/or true-persistence graphics.

In some examples, circuitry 404 may detect, recognize, and/or identify an event 422 that triggers and/or activates a bonus feature 420 of electronic wagering game 418. In one example, event 422 may include and/or represent a random occurrence, a performance-driven occurrence, a wager-driven occurrence, and/or a time-driven occurrence. For example, event 422 may occur as a result of random number generation. Additionally or alternatively, event 422 may occur as a result of a certain amount of time having elapsed since a previous bonus was awarded by electronic wagering game 418.

In some examples, circuitry 404 may detect, recognize, and/or identify at least one metric that represents the apparent progress toward unlocking bonus feature 420 in connection with one or more of metamorphic visuals 434(1)-(N). In one example, this metric may include and/or represent a counter that tracks and/or corresponds to the amount of time that has elapsed since the last time a certain bonus (e.g., a hold-and spin feature) was awarded by electronic wagering game 418. In certain implementations, circuitry 404 may detect event 422 by determining that the metric has reached a certain threshold for awarding bonus feature 420.

In some examples, circuitry 404 may implement and/or execute bonus feature 420 of electronic wagering game 418 in response to event 422. In one example, bonus feature 420 may include and/or represent a hold-and-spin feature awarded and/or granted to the user during gameplay. In this example, the hold-and-spin feature may include and/or represent a game mechanic in which the user is awarded and/or granted a certain number of spins (e.g., 3 spins). For example, circuitry 404 may allot a certain number of spins of reels 426 to the user in connection with the hold-and-spin feature. Circuitry 404 may later terminate the hold-and-spin feature upon determining that the user has completed all the spins allotted to the user.

During the hold-and-spin feature, each spin of reels 426 may render and/or display certain symbols (e.g., COR symbols and/or non-COR symbols). If reels 426 render and/or display one or more COR symbols during a spin, the COR symbols may be held in place during subsequent spins of the hold-and-spin feature. In other words, because those COR symbols are held in place, only non-COR symbols may rotate and/or change during the subsequent spins of the hold-and-spin feature.

In some examples, if reels 426 render and/or display one or more COR symbols during a spin, electronic wagering game 418 may increase the number of spins available to the user during the hold-and-spin feature. For example, if the user lands one or more COR symbols on the last remaining spin of the hold-and-spin feature, electronic wagering game 418 may reset and/or restore the user's spins to the original number (e.g., 3 spins) awarded and/or granted to the user. In certain implementations, and as will be described in greater detail below, electronic wagering game 418 may award and/or attribute the value of the COR symbols that land during the hold-and-spin feature to the user at one or more intervals (e.g., as a mid-bonus win-all, collect-all, and/or roll-up or as an end-of-bonus win-all, collect-all, and/or roll-up).

In some examples, during the implementation of bonus feature 420, circuitry 404 may detect, recognize, and/or identify an event 424 that triggers and/or activates a first collection of one or more values 436 represented by one or more symbols that land on reels 426. For example, circuitry 404 may detect an event that triggers and/or activates a mid-bonus win-all, collect-all, and/or roll-up of all the COR symbols that appear on reels 426. In one example, event 424 may include and/or represent a random occurrence, a performance-driven occurrence, a wager-driven occurrence, and/or a time-driven occurrence. For example, event 424 may occur as a result of random number generation. Additionally or alternatively, event 424 may occur as a result of a certain amount of time having elapsed since a previous collection was performed or since the start of bonus feature 420.

In some examples, circuitry 404 may detect, recognize, and/or identify at least one metric that represents the apparent progress toward unlocking the first collection during bonus feature 420 in connection with one or more of metamorphic visuals 434(1)-(N). In one example, this metric may include and/or represent a counter that tracks and/or corresponds to the amount of time that has elapsed since a previous collection was performed or since the start of bonus feature 420. In certain implementations, circuitry 404 may detect event 424 by determining that the metric has reached a certain threshold for awarding the first collection.

In some examples, circuitry 404 may implement and/or perform this first collection during bonus feature 420 in response to event 422. For example, as part of this first collection, circuitry 404 may identify all the COR symbols appearing on reels 426 at the time of event 424. In this example, circuitry 404 may then attribute the values of those COR symbols (e.g., a sum of the values) to the user.

In some examples, circuitry 404 may terminate and/or end bonus feature 420 once the user has completed all the spins allotted to the user in connection with bonus feature 420. In one example, upon completion of bonus feature 420, circuitry 404 may implement and/or perform a second collection of one or more values represented by the COR symbols that landed on reels 426 during bonus feature 420. In other words, circuitry 404 may implement and/or perform this second collection in response to the completion of bonus feature 420. In certain implementations, because all the COR symbols whose values were attributed to the user in the first collection are held over until the second collection, circuitry 404 may attribute those values to the user again as part of the second collection. Accordingly, the second collection may involve reattributing all the values from the first collection to the user as well as attributing the values of any COR symbols that subsequently landed on reels 426 after the first collection.

In some examples, circuitry 404 may direct and/or cause display device 406 to render and/or present one or more visual effects 432(1)-(N) corresponding to event 422 and/or event 424. For example, circuitry 404 may direct and/or cause display device 406 to animate one or more of metamorphic visuals 434(1)-(N) in graphical interface 428 to indicate that bonus feature 420 has been awarded to the user. Additionally or alternatively, circuitry 404 may direct and/or cause display device 406 to animate one or more of metamorphic visuals 434(1)-(N) in graphical interface 428 to indicate that the first collection has been awarded to and/or performed for the user. Such animations may communicate and/or convey, to the user, that event 422 and/or event 424 has occurred. Additionally or alternatively, circuitry 404 may direct and/or cause display device 406 to animate one or more of metamorphic visuals 434(1)-(N) in graphical interface 428 to indicate that the second collection has been awarded to and/or performed for the user.

In some examples, circuitry 404 may include and/or represent one or more electrical and/or electronic circuits capable of processing, applying, modifying, transforming, displaying, transmitting, receiving, and/or executing data for system 400. Circuitry 404 may be communicatively and/or electrically coupled to display device 406. In one example, circuitry 404 may access and/or analyze data stored in memory to facilitate and/or support activating and/or displaying visual effects 432(1)-(N) corresponding to events in connection with bonus feature 420. Additionally or alternatively, circuitry 404 may launch, perform, and/or execute certain executable files, code snippets, and/or computer-readable instructions to facilitate and/or support activating and/or displaying visual effects 432(1)-(N) corresponding to events in connection with bonus feature 420. In certain implementations, circuitry 404 may provide display device 406 with instructions and/or commands that, upon execution, cause display device 406 to present and/or modify graphical interface 428 in accordance with the progression of electronic wagering game 418.

Although illustrated as a single unit in FIG. 1, circuitry 404 may include and/or represent a collection of multiple processing units and/or electrical or electronic components that work and/or operate in conjunction with one another. In one example, circuitry 404 may include and/or represent a central processing unit (CPU) and/or a graphics processing unit (GPU). In another example, circuitry 404 may include and/or represent an application-specific integrated circuit (ASIC). In certain implementations, circuitry 404 may be included and/or incorporated in an EGM. Additionally or alternatively, circuitry 404 may be included and/or incorporated in a server and/or one or more client devices of system 400. Examples of circuitry 404 include, without limitation, processing devices, microprocessors, microcontrollers, GPUs, CPUs, ASICs, field-programmable gate arrays (FPGAs), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, and/or any other suitable circuitry.

In some examples, the various devices, components, and/or features described in connection with FIG. 4 may include and/or represent one or more additional circuits, components, and/or features that are not necessarily illustrated and/or labeled in FIG. 4. For example, the systems, components, and/or features illustrated in FIG. 4 may also include and/or represent additional analog and/or digital circuitry, onboard logic, transistors, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, combinations or variations of one or more of the same, and/or any other suitable components. In certain implementations, one or more of these additional circuits, components, and/or features may be inserted and/or applied between any of the existing circuits, components, and/or features illustrated in FIG. 4 consistent with the aims and/or objectives described herein. Accordingly, the couplings and/or connections described with reference to FIG. 4 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

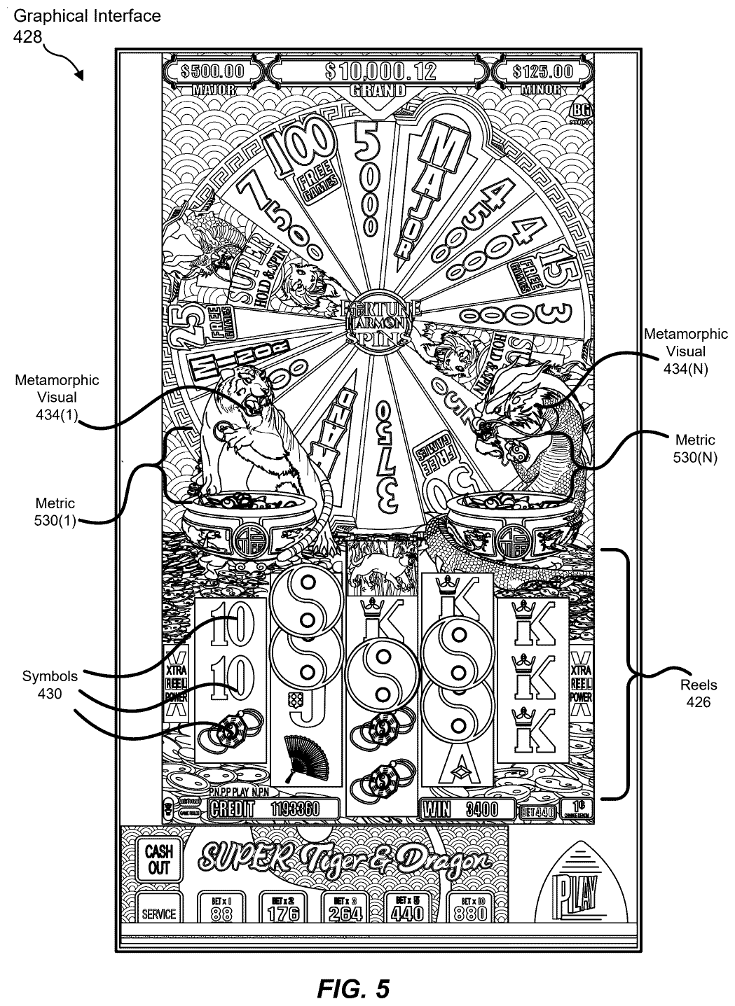

FIGS. 5-12 illustrate an exemplary implementation of graphical interface 428 presented via display device 406. In some examples, graphical interface 428 may include and/or represent certain elements, components, and/or features that perform and/or provide functionalities that are similar and/or identical to those described above in connection with any of FIGS. 1-4. As illustrated in FIGS. 5-12, graphical interface 428 may include and/or represent metamorphic visuals 434(1)-(N), metrics 530(1)-(N), and/or symbols 430 on reels 426.

In some examples, metrics 530(1)-(N) may include and/or represent the apparent progress of a user toward unlocking bonus feature 420 in connection with metamorphic visuals 434(1)-(N). In one example, circuitry 404 may detect and/or monitor metrics 530(1)-(N). Additionally or alternatively, circuitry 404 may direct display device 406 to modify metamorphic visuals 434(1)-(N) commensurate with metrics 530(1)-(N). In this example, metrics 530(1)-(N) may correspond to and/or represent durations and/or amounts of time since the last time a certain bonus (e.g., bonus feature 420) was awarded to the user in connection with metamorphic visuals 434(1)-(N), respectively.

In some examples, circuitry 404 may detect and/or monitor activity that involves and/or relates to reels 426 prior to, during, and/or after the implementation of bonus feature 420. In one example, the activity may result from and/or be caused by one or more interactions (such as wagers) between the user and/or electronic wagering game 418. Additionally or alternatively, circuitry 404 may direct display device 406 to modify metamorphic visuals 434(1)-(N) commensurate with metrics 530(1)-(N). In this example, metrics 530(1)-(N) may correspond to and/or represent durations and/or amounts of time since the last time a certain bonus (e.g., bonus feature 420) was awarded to the user in connection with metamorphic visuals 434(1)-(N), respectively. In certain implementations, metamorphic visuals 434(1)-(N) may reflect and/or represent metrics 530(1)-(N), respectively. For example, metamorphic visuals 434(1)-(N) may include and/or represent a component or feature that reflects the durations or amounts of time since bonus feature 420 was awarded to the user in connection with metamorphic visuals 434(1)-(N).

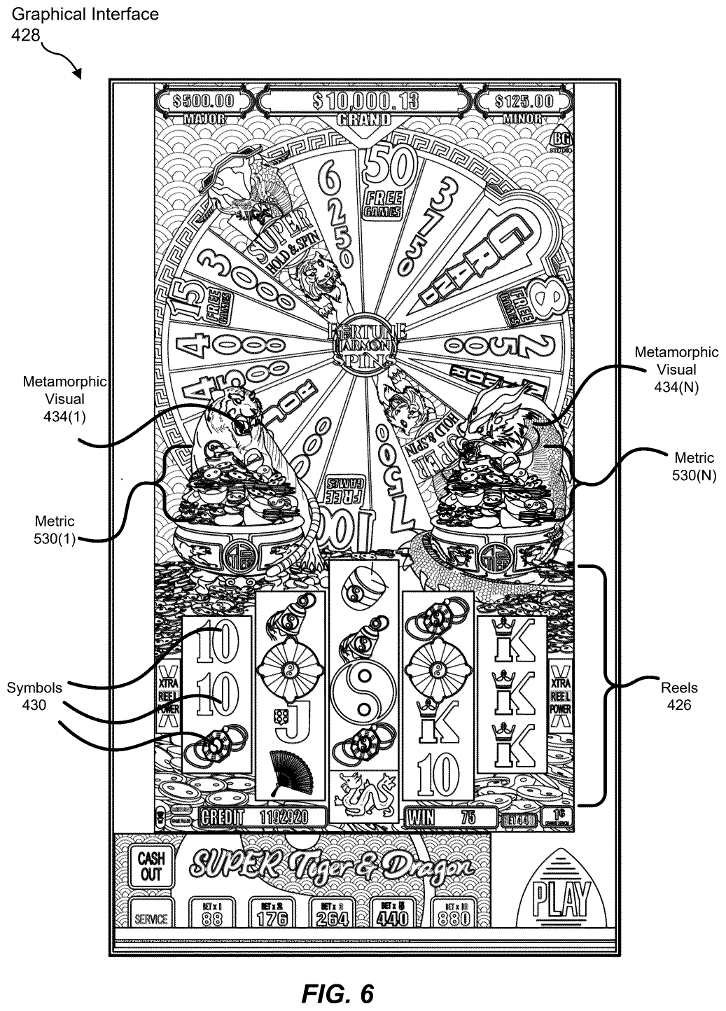

As a specific example, metamorphic visual 434(1) may include and/or represent a graphical representation of a tiger, and metamorphic visual 434(N) may include and/or represent a graphical representation of a dragon. In this example, metamorphic visuals 434(1)-(N) may each also include and/or represent a graphical representation of a bowl that fills with coins commensurate with metrics 530(1)-(N), respectively. As illustrated in FIGS. 5 and 6, the graphical bowls included in metamorphic visuals 434(1)-(N) may fill with graphical coins as time elapses since the last instance of bonus feature 420 was awarded and/or granted. In certain implementations, the time relevant to metamorphic visuals 434(1)-(N) may elapse over a single game and/or a single wagering cycle. In other implementations, the time relevant to metamorphic visuals 434(1)-(N) may elapse over multiple games and/or multiple wagering cycles.

In some examples, circuitry 404 may award and/or grant an instance of bonus feature 420 to the user based at least in part on random number generation. In one example, circuitry 404 may direct and/or cause display device 406 to render and/or present visual effect 432(1) by animating one or more of metamorphic visuals 434(1)-(N). For example, if bonus feature 420 is awarded in connection with metamorphic visual 434(1), circuitry 404 may direct and/or cause the graphical coins to fall out of and/or drop from the graphical bowl included in metamorphic visual 434(1). Additionally or alternatively, if bonus feature 420 is awarded in connection with metamorphic visual 434(N), circuitry 404 may direct and/or cause the graphical coins to fall out of and/or drop from the graphical bowl included in metamorphic visual 434(N). In certain implementations, if bonus feature 420 is awarded in connection with both of metamorphic visuals 434(1)-(N), circuitry 404 may direct and/or cause the graphical coins to fall out of and/or drop from the graphical bowls included in metamorphic visuals 434(1)-(N).

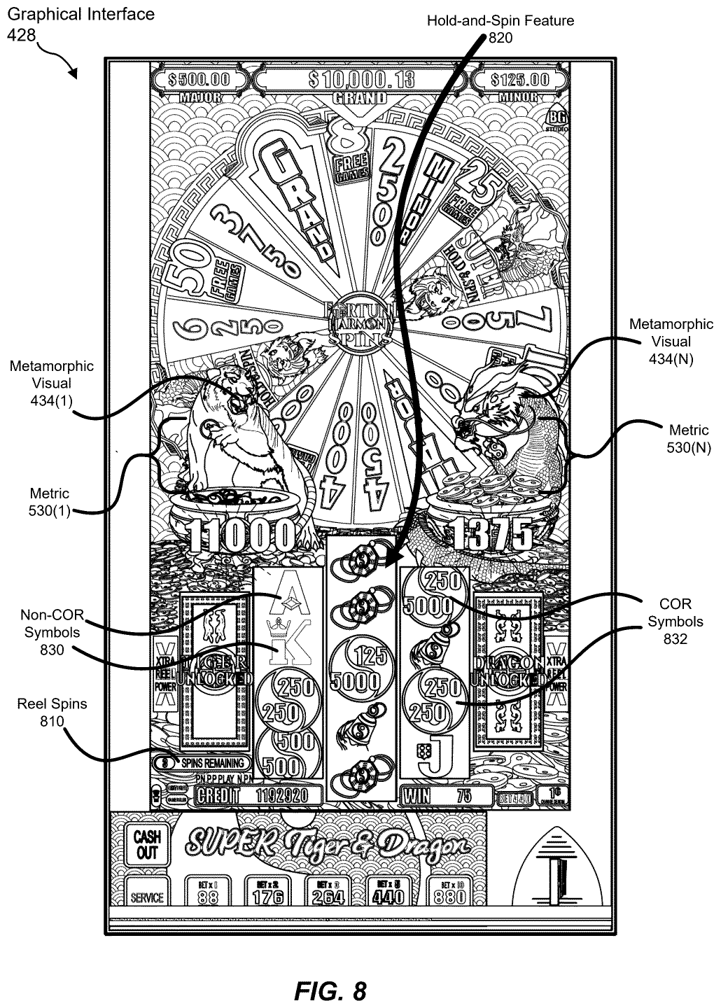

In some examples, as illustrated in FIG. 8, bonus feature 420 may include and/or represent a hold-and-spin feature 820. In one example, during hold-and-spin feature 820, reels 426 may include and/or represent COR symbols 832 and/or non-COR symbols 830. In this example, circuitry 404 may spin and/or rotate reels 426 to change among COR symbols 832 and/or non-COR symbols 830. However, if reels 426 render and/or display one or more of COR symbols 832 during a spin, circuitry 404 may hold those COR symbols in place during subsequent spins of hold-and-spin feature 820. Accordingly, because those COR symbols are held in place, circuitry 404 may spin and/or rotate only non-COR symbols 830 during subsequent spins of hold-and-spin feature 820.

In some examples, circuitry 404 may allot a certain number of reel spins 810 to the user in connection with hold-and-spin feature 820. In one example, circuitry 404 may decrement the number of reel spins 810 every time the user performs a reel spin. However, if reels 426 render and/or display one or more of COR symbols 830 during a spin, circuitry 404 may increment and/or increase the number of spins available to the user during hold-and-spin feature 820.

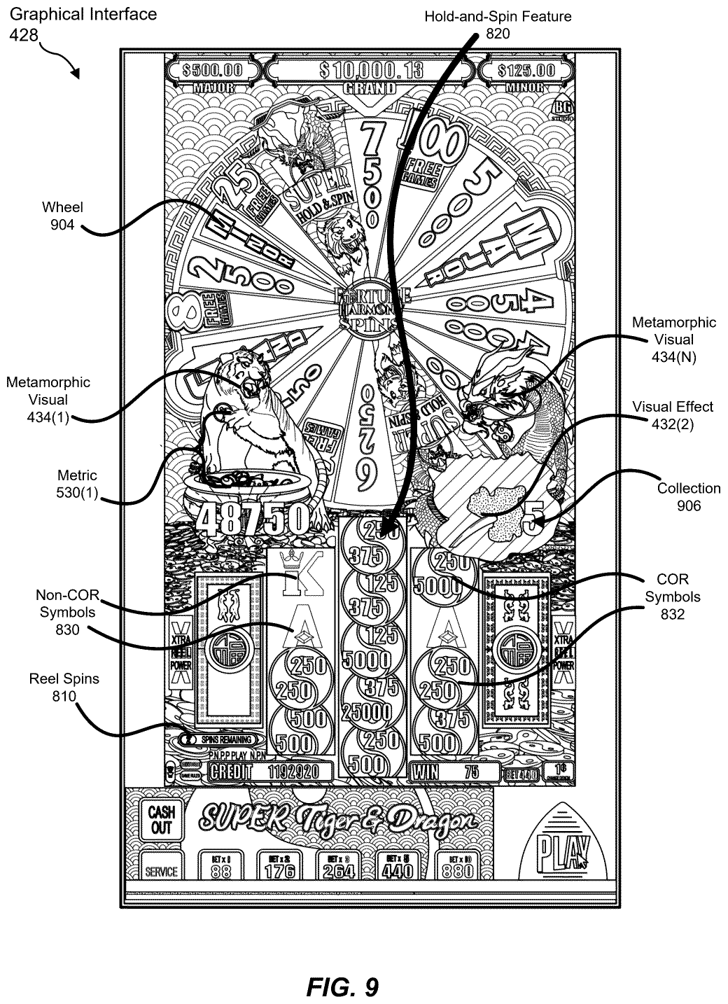

In some examples, as illustrated in FIG. 9, circuitry 404 may award and/or grant a collection 906 to the user during hold-and-spin feature 820 based at least in part on random number generation. In one example, as part of collection 906, circuitry 404 may perform and/or execute a mid-bonus win-all, collect-all, and/or roll-up of the values shown on COR symbols 832. In this example, circuitry 404 may cause and/or direct display device 106 to implement and/or apply a visual effect 432(2) to metamorphic visual 434(N) in connection with collection 906. For example, as part of visual effect 432(2), circuitry 404 may animate all or a portion of metamorphic visual 434(N) to notify the user that the mid-bonus win-all, collect-all, and/or roll-up is occurring.

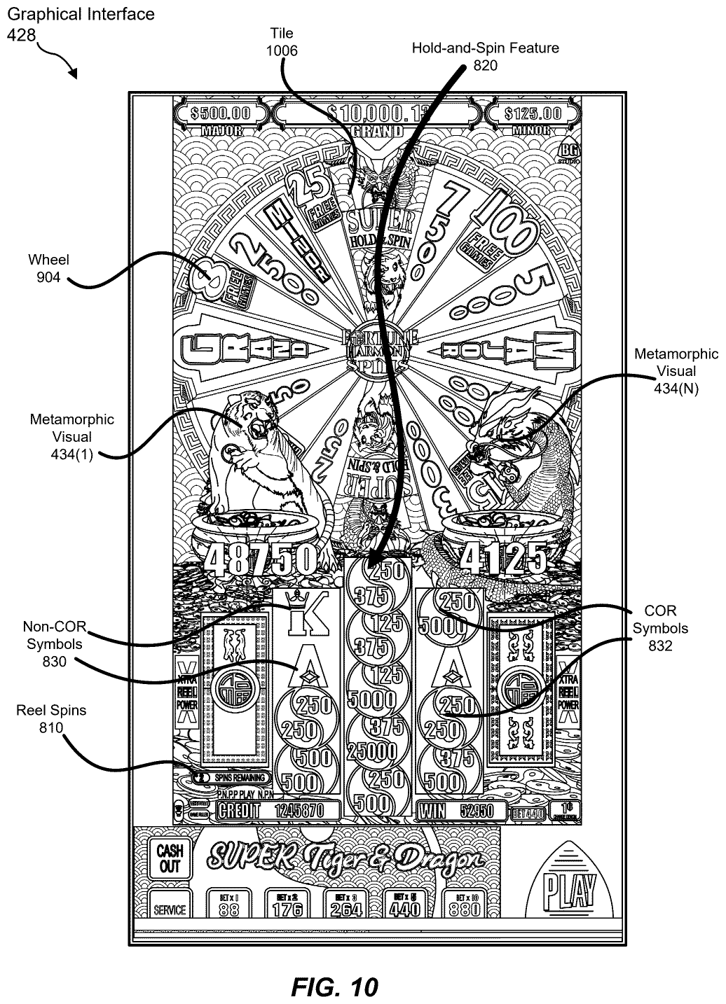

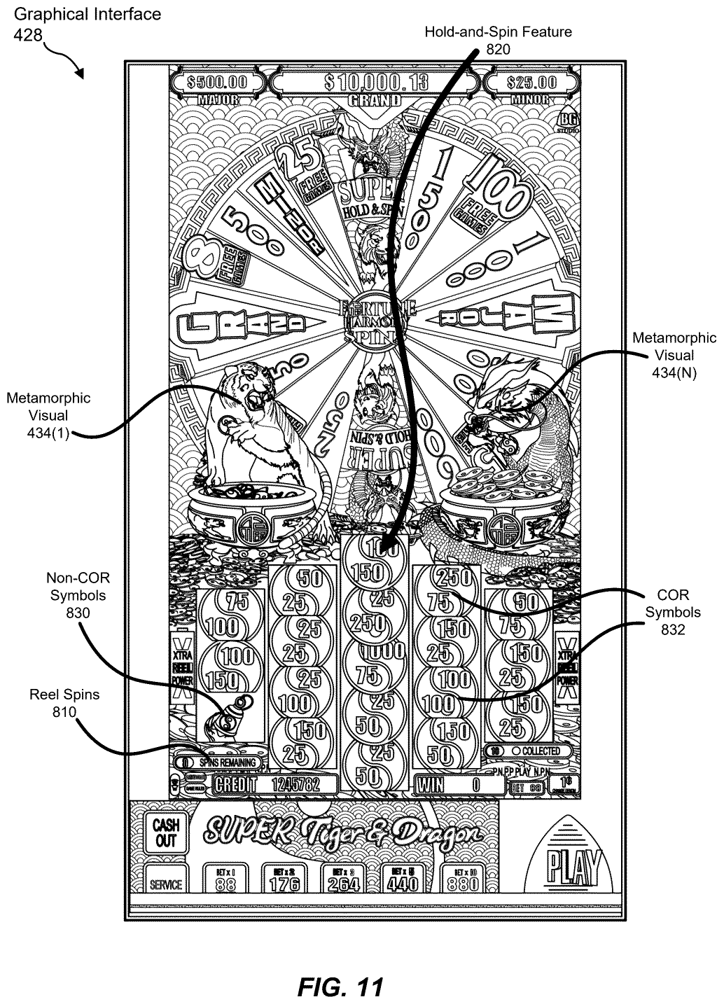

In some examples, graphical interface 428 may include and/or represent a wheel 904 composed of various tiles capable of enhancing hold-and-spin feature 820. For example, as illustrated in FIGS. 10 and 11, if hold-and-spin feature 820 normally includes only 3 reels with symbols, wheel 904 may include and/or represent a tile 1006 (e.g., a “SUPER HOLD & SPIN” tile) that expands the number of reels available during hold-and-spin feature 820 from 3 reels to 5 reels. In this example, if the wheel lands on tile 1006 during hold-and-spin feature 820, circuitry 404 may direct and/or cause graphical interface 428 to expand to 5 reels.

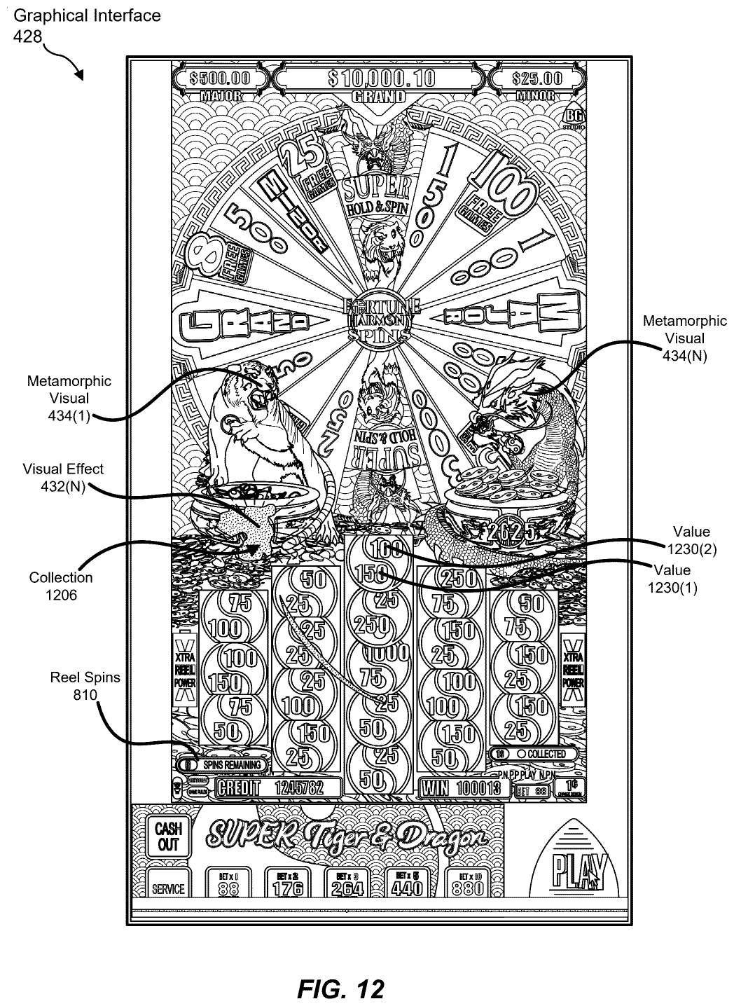

In some examples, circuitry 404 may terminate and/or end hold-and-spin feature 820 once the user has completed all of reel spins 810. In one example, as illustrated in FIG. 12, upon completion of hold-and-spin feature 820, circuitry 404 may implement and/or perform a collection 1206 of one or more values, such as values 1230(1)-(2), represented by the COR symbols 832 that landed on reels 426 during hold-and-spin feature 820. In other words, circuitry 404 may implement and/or perform collection 1206 in response to the completion of hold-and-spin feature 820. In certain implementations, because all of COR symbols 832 whose values were attributed to the user in collection 906 are held over until collection 1206, circuitry 404 may attribute those values to the user again as part of collection 1206. Accordingly, collection 1206 may involve reattributing all the values from collection 906 to the user as well as attributing the values of any of COR symbols 832 that subsequently landed on reels 426 after collection 906.

In some examples, as part of collection 1206, circuitry 404 may perform and/or execute an end-of-bonus win-all, collect-all, and/or roll-up of the values shown on COR symbols 832. In one example, circuitry 404 may cause and/or direct display device 106 to implement and/or apply a visual effect 432(N) to metamorphic visual 434(1) in connection with collection 1206. For example, as part of visual effect 432(N), circuitry 404 may animate all or a portion of metamorphic visual 434(1) to notify the user that the end-of-bonus win-all, collect-all, and/or roll-up is occurring.

In some examples, one or more of COR symbols 832 may include and/or represent two values-one corresponding to metamorphic visual 434(1) and another one corresponding to metamorphic visual 434(N). For example, a COR symbol may show and/or display value 1230(1) corresponding to metamorphic visual 434(1) and value 1230(2) correspond to metamorphic visual 434(N). In one example, when collection 906 is awarded and/or granted, circuitry 404 may attribute at least values 1230(1)-(2) to the user via metamorphic visuals 434(1)-(N), respectively. In this example, when collection 1206 is awarded and/or granted, circuitry 404 may again attribute at least values 1230(1)-(2) to the user via metamorphic visuals 434(1)-(N), respectively.

FIG. 13 is a flow diagram of an exemplary computer-implemented method 1300 for displaying visual effects corresponding to events that occur in connection with bonus features of electronic wagering games. In one example, the steps shown in FIG. 13 may be achieved and/or accomplished by an EGM and/or a server implementing an electronic wagering game. Additionally or alternatively, the steps shown in FIG. 13 may incorporate and/or involve certain sub-steps and/or variations consistent with the descriptions provided above in connection with FIGS. 1-12.

As illustrated in FIG. 13, method 1300 may include the step of detecting, by circuitry, a first event that triggers a bonus feature of an electronic wagering game (1302). Step 1310 may be performed in a variety of ways, including any of those described above in connection with FIGS. 1-12. For example, circuitry may detect a first event that triggers a bonus feature of an electronic wagering game.

Method 1300 may also include the step of detecting, by the circuitry during implementation of the bonus feature, a second event that triggers a first collection of one or more values represented by one or more symbols on one or more reels of the electronic wagering game (1304). Step 1320 may be performed in a variety of ways, including any of those described above in connection with FIGS. 1-12. For example, the circuitry may detect, during implementation of the bonus feature, a second event that triggers a first collection of one or more values represented by one or more symbols on one or more reels of the electronic wagering game.

Method 1300 may further include the step of performing, by the circuitry upon completion of the bonus feature, a second collection of the values represented by the symbols on the reels (1306). Step 1330 may be performed in a variety of ways, including any of those described above in connection with FIGS. 1-12. For example, the circuitry may perform, upon completion of the bonus feature, a second collection of the values represented by the symbols on the reels.

Method 1300 may further include the step of directing, by the circuitry, a display device to render one or more visual effects corresponding to the first event and the second event (1308). Step 1340 may be performed in a variety of ways, including any of those described above in connection with FIGS. 1-12. For example, the circuitry may direct a display device to render one or more visual effects corresponding to the first event and the second event.

In some examples, one or more of the components and/or devices illustrated in FIGS. 1-12 need not be present to practice the embodiments described and/or illustrated herein. The devices and subsystems referenced above are also interconnected in different ways from those shown in FIGS. 1-12. One or more of the devices and/or subsystems may be employed in any number of software, firmware, and/or hardware configurations. For example, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into one of the devices and/or subsystems in FIGS. 1-12. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein are implemented in firmware and/or hardware. For example, one or more of the devices and/or subsystems in FIGS. 1-12 is configured as an ASIC adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a display device; and
circuitry configured to:
detect a first event that triggers a bonus feature of an electronic wagering game;
detect, during implementation of the bonus feature, a second event that triggers a first collection of one or more values represented by one or more symbols on one or more reels of the electronic wagering game;
perform, upon completion of the bonus feature, a second collection of the values represented by the symbols on the reels; and
direct the display device to render one or more visual effects corresponding to the first event and the second event.

2. The system of claim 1, wherein the circuitry is further configured to direct the display device to render, in a graphical interface of the electronic wagering game, one or more metamorphic visuals corresponding to the reels.

3. The system of claim 2, wherein the circuitry is further configured to:
detect, prior to the implementation of the bonus feature, activity that involves the reels and results from an interaction between a user and the electronic wagering game; and
direct the display device to modify at least one of the metamorphic visuals prior to the implementation of the bonus feature based at least in part on the activity.

4. The system of claim 2, wherein the circuitry is further configured to:
detect, during the implementation of the bonus feature, activity that involves the reels and results from an interaction between a user and the electronic wagering game; and
direct the display device to modify at least one of the metamorphic visuals during the implementation of the bonus feature based at least in part on the activity.

5. The system of claim 2, wherein the circuitry is further configured to:
detect at least one metric that represents apparent progress toward unlocking the bonus feature in connection with at least one of the metamorphic visuals; and
direct the display device to modify the at least one of the metamorphic visuals commensurate with the metric.

6. The system of claim 5, wherein the first event comprises determining that the metric that represents the apparent progress toward unlocking the bonus feature has reached a certain threshold.

7. The system of claim 5, wherein:
the metamorphic visuals comprise a plurality of graphical bowls configured to fill with graphical coins commensurate with the metric; and
the visual effects comprise:
a first animation that corresponds to the first event and involves at least one of the graphical bowls or the graphical coins; and
a second animation that corresponds to the second event and involves at least one of the graphical bowls or the graphical coins.

8. The system of claim 2, wherein the circuitry is further configured to:
allot a certain number of reel spins to a user in connection with the bonus feature; and
terminate the bonus feature upon determining that the user has completed the certain number of reel spins.

9. The system of claim 8, wherein the circuitry is further configured to:
attribute, to the user as part of the first collection, the values represented by the symbols on the reels in response to the first event; and
attribute, to the user as part of the second collection, the values represented by the symbols on the reels in response to the second event.

10. The system of claim 2, wherein the circuitry is further configured to:
detect at least one metric that represents apparent progress toward unlocking the first collection during the bonus feature in connection with at least one of the metamorphic visuals; and
direct the display device to modify the at least one of the metamorphic visuals commensurate with the metric.

11. The system of claim 10, wherein the second event comprises determining that the metric that represents the apparent progress toward unlocking the first collection has reached a certain threshold.

12. The system of claim 2, wherein:
the metamorphic visuals comprise a first metamorphic visual and a second metamorphic visual; and
each symbol represents a first value corresponding to the first metamorphic visual and a second value corresponding to the second metamorphic visual.

13. The system of claim 12, wherein the circuitry is further configured to:
attribute, to a user as part of the first collection, a first instance of each first value corresponding to the first metamorphic visual and a first instance of each second value corresponding to the second metamorphic visual; and
attribute, to the user as part of the second collection, a second instance of each first value corresponding to the first metamorphic visual and a second instance of each second value corresponding to the second metamorphic visual.

14. The system of claim 2, wherein the circuitry is further configured to:
detect, after the second event and before the completion of the bonus feature, an addition of at least one other symbol on the reels; and
attribute, to a user as part of the second collection, at least one other value represented by the other symbol on the reels in response to the second event.

15. The system of claim 2, wherein the bonus feature comprises a hold-and-spin feature of the electronic wagering game.

16. A computer-implemented method comprising:
detecting, by circuitry, a first event that triggers a bonus feature of an electronic wagering game;
detecting, by the circuitry during implementation of the bonus feature, a second event that triggers a first collection of one or more values represented by one or more symbols on one or more reels of the electronic wagering game;
performing, by the circuitry upon completion of the bonus feature, a second collection of the values represented by the symbols on the reels; and
directing, by the circuitry, a display device to render one or more visual effects corresponding to the first event and the second event.

17. The method of claim 16, further comprising directing, by the circuitry, the display device to render, in a graphical interface of the electronic wagering game, one or more metamorphic visuals corresponding to the reels.

18. The method of claim 17, further comprising:
detecting, by the circuitry prior to the implementation of the bonus feature, activity that involves the reels and results from an interaction between a user and the electronic wagering game; and
directing, by the circuitry, the display device to modify at least one of the metamorphic visuals prior to the implementation of the bonus feature based at least in part on the activity.

19. The method of claim 17, further comprising:
detecting, by the circuitry during the implementation of the bonus feature, activity that involves the reels and results from an interaction between a user and the electronic wagering game; and
directing, by the circuitry, the display device to modify at least one of the metamorphic visuals during the implementation of the bonus feature based at least in part on the activity.

20. A non-transitory computer-readable medium comprising one or more computer-executable instructions that, when executed by at least one hardware processor of a computing device, cause the hardware processor to:
detect a first event that triggers a bonus feature of an electronic wagering game;
detect, during implementation of the bonus feature, a second event that triggers a first collection of one or more values represented by one or more symbols on one or more reels of the electronic wagering game;
perform, upon completion of the bonus feature, a second collection of the values represented by the symbols on the reels; and
direct a display device to render one or more visual effects corresponding to the first event and the second event.
